(19) United States
(12) Patent Application Publication
(10) Pub. No.: US 2014/0127361 A1
(43) Pub. Date: May 8, 2014

(54) EXTRUDED DELIVERY SYSTEM

(71) Applicants: Christorpher M. Gregson, Princeton, NJ (US); Matthew P. Sillick, Hamilton, NJ (US)

(72) Inventors: Christorpher M. Gregson, Princeton, NJ (US); Matthew P. Sillick, Hamilton, NJ (US)

(73) Assignee: FIRMENICH SA, Geneva 8 (CH)

(21) Appl. No.: 14/126,155

(22) PCT Filed: Jun. 15, 2012
(86) PCT No.: PCT/EP2012/061461

§ 371 Date: Dec. 13, 2013

Related U.S. Application Data
(60) Provisional application No. 61/500,263, filed on Jun. 23, 2011.

(30) Foreign Application Priority Data
Jun. 29, 2011 (EP) 11171984.5

(51) Int. Cl. A23L 1/22

(52) U.S. Cl. CPC A23L 1/22016
USPC 426/96; 426/515; 426/650

(57) ABSTRACT

The present invention relates to an extruded delivery system. It also relates to a process for preparing such a extruded delivery system.

### TECHNICAL FIELD

The present invention relates to an extruded delivery system. It also relates to a process for preparing such a extruded delivery system.

### BACKGROUND AND PRIOR ART

Delivery systems or encapsulation systems are used in various industries to protect active ingredients. For instance, in the food industry they are often used to protect flavors, in particular against losses of volatile components (i) during storage prior to incorporation into the food products, (ii) during mixing of the flavor component with the other food ingredients, (iii) during food processing, such as cooking and baking, (iv) during transportation and storage and (v) during the preparation of the food product by the end-consumer.

Similarly, in the nutraceutical industry, they are often used to protect oxygen-sensitive active material, such as fish oils rich in polyunsaturated fatty acids, by providing an oxygen bather around the material.

In the fragrance industry it is known to encapsulate perfumes for use in homecare products such as fabric conditioners. This enables the perfumes to be deposited onto the fabric without being degraded and released gradually over a longer period than when unencapsulated.

Due to the importance of delivery systems across a broad array of fields, it is not surprising that various different types of delivery system exist. Among the different systems known in the art, extrusion methods typically rely on the use of carbohydrate encapsulating (matrix) materials which are rendered to a molten state and combined with the active ingredient(s), such as an oxygen sensitive oil, before extruding and quenching the extruded mass to form a glass which protects the active ingredient(s). Such extrusion methods are typically referred to as “melt-extrusion”.

Extruded delivery systems formed by melt-extrusion typically comprise an encapsulating carrier (matrix) for a material, product or ingredient that is encapsulated. The matrix material is often described as “viscous” or “rubbery” during the extrusion process and “glassy” in the finished product. The temperature at which the matrix material transitions between the glassy and rubbery states is known as the glass transition temperature (referred to herein as “Tg”). A protocol for measuring the Tg of a material such as a matrix material is given in the publication Maltodextrin molecular weight distribution influence on the glass transition temperature and viscosity in aqueous solutions F. Avaltroni, P. E. Bouquerand and V. Normand Carbohydrate Polymers, 2004, Volume 58, Issue 3, 323-334.

It is recognised by many experts in the field that, in the glassy state, i.e. at temperatures below the Tg, all molecular translation is halted and it is this which provides effective entrapping of the flavor volatiles and prevention of other chemical events such as oxidation. Conversely, at temperatures above the Tg, the encapsulation of materials, products and ingredients is ineffective since the rubbery matrix allows the material to be encapsulated to leak.

Thus, the higher the Tg, the more stable the final product is upon storage. However, a higher Tg is known to render more difficult the extrusion conditions since the temperature in the extruder must be raised even higher to allow the mixture to flow under extrusion conditions and to enable the matrix and material to be encapsulated to mix intimately. Such high temperatures can have a variety of adverse effects: loss of volatile materials; unwanted reactions between matrix (encapsulating) ingredients and the active material; and increased energy requirements and consequential manufacturing cost.

The encapsulating carrier needs to be sufficiently liquid during the early stages of processing so that droplets of the active ingredient can be dispersed within it and then rendered into diverse shapes such as strands or droplets. On the other hand, hardening then needs to take place within an appropriate time scale. Particles falling through air may have only seconds within which they must harden, while strands extruded onto a solid surface may be afforded up to tens of minutes.

Balancing the needs for both a sufficiently low viscosity during extrusion and a sufficiently solid glass after extrusion is a problem especially associated with melt-extrusion processes and products since matrices that do not require such a melt processing step are not exposed to these difficulties.

Accordingly, it would be desirable to provide an extruded delivery system having a high Tg but which remains readily or easily processed under extrusion conditions.

It has been suggested in Carbohydrate research, 2010, 345(2), 303-308 that crystallization of sugar hydrates (particularly trehalose) could remove water and thereby increase the Tg of an encapsulate prepared by freeze-drying. During crystallization the sugar absorbs water and thereby removes water, which is the plasticizer of the system, so that the Tg of the amorphous phase increases. However, crystallization of the hydrates tends to take place only in water-rich regimes. Melts with low moisture contents will need to be heated to higher temperature in order to afford mobility for crystallization and they may then be more likely to crystallize in the anhydrous form and thus not increase the Tg. According to that document, the water content needed to form trehalose dihydrate is of 9.5% and the water content needed to form raffinose pentahydrate is of 15.1%, these percentages being defined by weight based on the total weight of water and solids. Furthermore, that document states that the good performance of sugars that form hydrated crystals as bioprotectants is not related to the decreased water content or the increase of Tg of the amorphous phase. The latter effect is suggested to be temporary and shorter than the expected shelf life of pharmaceuticals or food ingredients.

Milk powder can be spray dried in such a way to promote the crystallization of lactose (Chio et al. Drying technology, 26(1), 2008, pp. 567-570). Alternatively, the crystallization has been performed on milk powder after spray drying in a fluidized bed (Liang et al. Dairy Science Technology, 90(2-3), 2010, pp. 345-353). The benefit of crystallization is that it produces a more protein or polymer-rich matrix which is easier to dry and less hygroscopic. However, these documents are completely silent with regard to encapsulation techniques and extrusion in particular. Moreover, lactose is not suitable as a plasticizer since it has too high a Tg (about 100° C.). The Tg of the remaining amorphous fraction will be increased very little or not at all as lactose is crystallized out.

Accordingly, the present invention seeks to resolve one or more of these issues.

WO 2010/131207 discloses a delivery system comprising maltodextrin, trehalose and soya lecithin, but the process described implies a quenching inevitably lending to a glassy solid, to the contrary of the present invention's capsules which have a crystalline sugar.

### SUMMARY OF THE INVENTION

Surprisingly, it has now been found that an extruded delivery system comprising en encapsulating carrier comprising a crystalline component and an non-crystalline component, as defined below, addresses one or more of the problems identified above. Thus, according to the present invention there is provided an extruded delivery system comprising:

(a) an encapsulating carrier comprising
i) a crystalline component consisting of a material having a Tg below 30° C. when it is in an amorphous state and
ii) an amorphous component in the glassy state; and

(b) an encapsulated liquid active ingredient.

The invention further relates to a method of preparing an extruded delivery system comprising the steps of:

(a) forming a melt comprising (i) a crystal-forming material having a Tg below 30° C. and (ii) a glass-forming material;

(b) incorporating an active ingredient into the melt;

(c) forming a melt-mixture comprising an emulsion, dispersion, solution or suspension of the active ingredient in the melt;

(d) extruding the melt mixture, and

(e) tempering the extruded melt under conditions that enable crystallization of at least part of component (i) of the melt;

so as to form a solid delivery system.

### DETAILED DESCRIPTION

The extruded delivery system of the invention comprises an encapsulating carrier formed of at least one crystalline component together with at least one non crystalline component in the glassy state.

The crystalline component can be any material that is able to plasticize a melt under certain conditions and of forming crystals upon tempering under suitable conditions. Preferably, said crystalline component is not water. More preferably it is selected from erythritol, mannitol, sorbitol, xylitol or mixtures thereof. Even more preferably it is erythritol, mannitol or mixtures thereof. Most preferably it is erythritol.

When it is in the liquid state, the material forming the crystalline component has the benefit of being able to plasticize the melt in which is present, thus reducing the Tg and the viscosity of the melt and enabling easier extrusion. When it is tempered under conditions that lead to crystallization the plasticizing effect ceases and consequently it ceases to lower the Tg of the non-crystalline component of the carrier. Therefore, the Tg and the viscosity of the melt increases, which renders hardening of the extruded delivery system easier. It is noted that the crystallization of the material forming component (i) is never complete and that the extent to which the Tg and the viscosity are increased are a function of the amount of the material forming component (i) of the carrier that is actually crystallized. The elevation of the Tg and the increase in viscosity will be more important if the portion of the material forming component (i) is increased. The person skilled in the art is able to determine the necessary degree of crystallization of the material forming component (i), depending on the required elevation of the Tg and of the viscosity, in order to get a solid extruded product having the required stability.

The material forming the crystalline component of the carrier must have a Tg below 30° C., more preferably below 25° C. or even more preferably below 20° C. in a most preferred embodiment, such material has a melting point above 20° C., preferably above 25° C. and more preferably above 30° C., so that it can be a crystalline solid at room temperature. Preferably the melting point is not above 200° C., so that it can be liquid during processing.

Also, the material forming the crystalline component of the carrier is preferably miscible with the amorphous component, so that a uniform melt can be formed with these two materials.

The viscosity of the melt of both encapsulating components is typically lower than the viscosity of conventional extruded systems, which is advantageous since this renders the extrusion process easier, in particular as regards the formation of droplets. This is further advantageous as it can allow the extrusion to be accomplished at a lower temperature, which is beneficial to encapsulating highly volatile compounds such as acetaldehyde and dimethyl sulphide.

The non-crystalline component, can be any material of current use as glassy matrix components in extruded products. Such materials are water-soluble glass-forming ingredients which are miscible with the material forming the crystalline component so as to form a uniform melt and which have a high Tg. Preferably, such non-crystalline component is selected from polysaccharides (such as for example gum acacia, starches, modified starches, hydrolized starches (i.e. maltodextrins), alginates, pectin and carrageenan), proteins (such as for example gelatine of type A or B, whey protein, soy protein and sodium caseinate) and high Tg dissacharides (i.e. disaccharides having a Tg above 30° C., such as for example trehalose, maltose, sucrose and isomalt).

The carbohydrate preferably comprises a monosaccharide, an oligosaccharide, a polysaccharide or any modified form thereof. Particularly preferred are oligosaccharides, especially maltodextrin or mixtures of maltodextrins. Commercial maltodextrins are usually prepared from hydrolysis of a selected corn starch. The resulting maltodextrin products are obtained as complex mixtures of carbohydrate oligomers which also contain minor amounts of mono and disaccharides. Any commercial maltodextrin with a dextrose equivalent (referred to herein as “DE”) of 5 to 20 may be suitably used. However, maltodextrins with 10 to 20 DE are preferred. Most preferably maltodextrins having a DE of from 16 to 20 are used as these provide excellent TG and viscosity characteristics when used in combination with erythritol. DE as used in the present specification refers to the percentage of reducing sugars (dry basis) in a product calculated as dextrose. Suitable commercially available maltodextrin for use in the present invention include Glucidex 19, Glucidex 12, Glucidex 6 (ex Roquette Frères), Star Dri 18, Star-Dri 10, Star-Dri 5 (ex Tate and Lyle), Maltrin M180, Maltrin M150, Maltrin M100, Maltrin M040 (ex Grain Processing Corporation), Morrex 1920, Morrex 1910, Globe 1905 (Corn Products International), Maldex G190, Maldex G120 (ex Syral), Dry MD019181, Dry MD019091 (ex Cargill). Other commercial maltodextrin-like materials obtained from rice, wheat, and tapioca starches as well as agglomerated forms of maltodextrins such as the Glucidex 6IT, 8IT, 12IT and 19IT (ex Roquette Frères).

Alternatively or additionally, it may be preferable that the carbohydrate comprises sugars such as mono-, di or trisaccharides, provided they demonstrate suitably high Tg values, as described below.

It is however understood that materials falling within the definition of the material forming the crystalline component of the carrier, according to any of the embodiments mentioned above, are excluded from the definition of the materials forming the amorphous component.

More preferably, the non-crystalline component is one or more hydrogenated starch hydrolysates having number average degree of polymerization, DPn, of between 5 and 100, or a number average molecular weight, Mn of between 800 and 16000 Da (referred to herein as “HSH”).

HSH includes hydrogenated glucose syrups, maltitol syrups, and sorbitol syrups, and is a family of products found in a wide variety of foods. HSH is produced by the partial hydrolysis of corn, wheat, or potato starch with the subsequent hydrogenation of the hydrolysate at high temperature under pressure. By varying the conditions and extent of the hydrolysis, the relative occurrence of various mono-, di-, oligo- and polymeric hydrogenated saccharides in the resulting product can be obtained.

Hydrogenated mono-, di-, oligo- and polysaccharides are characterized by the degree of polymerization (DP) or molecular weight (M). For example, hydrogenated monosaccharides have a DP of 1 and an M of 182 Da and hydrogenated disaccharides have a DP of 2 and an M of 344 Da. As HSH has a distribution of molecular weight fractions, a suitable average is often calculated. A convenient averaging scheme is the number average. The number average degree of polymerization, DPn, and the number average molecular weight, Mn, may be determined by routine HPLC analysis or cryoscopy (depression of freezing point), also called freezing point osmometry.

For the purposes of the present invention, the term HSH can be applied to any polyol produced by the hydrogenation of the saccharide products of starch hydrolysis. The term HSH is more commonly used to describe the broad group of polyols that contain substantial quantities of hydrogenated oligo- and poly-saccharides. For the purposes of the present invention, HSH is defined as a hydrogenated starch hydrolysate having number average DPn between 5 and 100. More preferably, the DPn is between 6 and 60. Even more preferably the DPn is between 6 and 40, most preferably between 6 and 20. The HSH may have a number average molecular weight, Mn of between 800 and 16000 Da, more preferably between 1000 and 3500 Da.

Preferably, the non-crystalline component has a Tg above 30° C., more preferably above 50° C., even more preferably above 100° C. and most preferably above 150° C. Such non-crystalline component are usually sold commercially as dried power that contain small amounts of water, so that the Tg of such commercial products is typically comprised between 80 and 150° C. Components having such a high Tg are advantageous because when the plasticizing effect of the crystalline component ceases upon crystallization of such component, the non crystallizing component will form a glassy matrix having good stability. The high Tg values mentioned above are advantageous because the non-crystalline component can accommodate the plasticizing effect of potential residual amounts of the material forming the crystalline which did not crystallize or of other plasticizers such as water that may be present while still forming a stable glass.

In the encapsulating carrier the amount of the material forming the crystalline component is preferably from 10 to 90% by weight based on the total dry weight of the encapsulating material. In consequence, the amount of the material forming the non-crystalline component is preferably from 10 to 90% by weight, based on the total dry weight of the encapsulating material. Outside of these ranges, certain disadvantages become apparent. For instance, at lower levels of the crystalline component the increase of Tg upon crystallization is significantly reduced and the benefit of reduced viscosity enabling easier extrusion is also reduced significantly when the component is in the molten state. At higher levels of crystalline component, a reduction or loss of the glassy structure around the encapsulated material would result. The glassy structure is highly desirable as it enables excellent retention of volatile encapsulated materials. Additionally, at higher levels the extrusion process can only be performed within a narrower temperature window above the melting point of the material forming the crystalline component because of the risk that crystallization will occur prematurely, ie. before the mixture has been shaped into the desired form.

More preferably, the amount of the material forming the crystalline component is of at least 30%, even more preferably at least 40%, most preferably at least 50%, based on the total dry weight of the encapsulating material, the amount of the material forming the non-crystalline material being consequently preferably of less than 70%, more preferably less than 60% and most preferably less than 50% by weight, based on the total dry weight of the encapsulating material. Such minimum amounts of crystal-forming material in the melted encapsulating material have the advantageous effect of reducing the time necessary for the crystallization to take place.

Preferably, the material forming the crystalline component is present in an amount of less than 75% by weight, based on the total dry weight of the encapsulating material, the amount of non-crystalline material being consequently of at least 25% by weight, based on the total dry weight of the encapsulating material.

The active ingredient to be encapsulated can designate a single compound or a composition, such as flavors, fragrances, pharmaceuticals, nutraceuticals or other ingredients, which one wishes to encapsulate. In another aspect of the invention, the active ingredient that can be encapsulated is a protein, for example an enzyme.

Preferably, the active ingredient is a volatile or labile flavoring, perfuming or nutraceutical ingredients or composition.

Preferably, the active ingredient is a hydrophobic liquid, which is soluble in organic solvents but only very weakly soluble in water. More particularly, a flavoring, perfuming or nutraceutical ingredient or composition encapsulated according to the invention is preferably characterised by a Hildebrand solubility parameter smaller than 30 [MPa]^{1/2}. The aqueous incompatibility of most oily liquids can be in fact expressed by means of Hildebrand's solubility parameter δ which is generally below 25 [MPa]^{1/2}, while for water the same parameter is of 48 [MPa]^{1/2}, and of 15-16 [MPa]^{1/2} for alkanes. This parameter provides a useful polarity scale correlated to the cohesive energy density of molecules. For spontaneous mixing to occur, the difference in δ of the molecules to be mixed must be kept to a minimum. The Handbook of Solubility Parameters (ed. A. F. M. Barton, CRC Press, Bocca Raton, 1991) gives a list of δ values for many chemicals as well as recommended group contribution methods allowing to calculate δ values for complex chemical structures.

The phrase “flavor or fragrance compound or composition” as used herein, thus defines a variety of flavor and fragrance materials of both natural and synthetic origin. They include single compounds and mixtures. Natural extracts can also be encapsulated in the extrudate; these include e.g. citrus extracts, such as lemon, orange, lime, grapefruit or mandarin oils, or essential oils of spices, amongst other. Particularly preferred active materials in this class for encapsulation are flavor compositions containing labile and reactive ingredients such as berry and dairy flavors.

Further specific examples of such flavor and perfume components may be found in the current literature, e.g. in Perfume and Flavour Chemicals, 1969, by S. Arctander, Montclair N.J. (USA); Fenaroli's Handbook of Flavour Ingredients, CRC Press or Synthetic Food Adjuncts by M. B. Jacobs, van Nostrand Co., Inc.. They are well-known to the person skilled in the art of perfuming, flavoring and/or aromatizing consumer products, i.e. of imparting an odour or taste to a consumer product.

An important class of oxygen-sensitive active materials that can be encapsulated in the delivery system of the present invention are “oils rich in polyunsaturated fatty acids”, also referred to herein as “oils rich in PUFA's”. These include, but are not limited to, oils of any different origins such as fish or algae. It is also possible that these oils are enriched via different methods such as molecular distillation, a process through which the concentration of selected fatty acids may be increased. Particularly preferred compositions for encapsulation are nutraceutical compositions containing polyunsaturated fatty acids and esters thereof.

Specific oils rich in PUFA's for use in the present delivery system include eicosapentanoic acid (EPA), docosahexanoic acid (DHA), arachidonic acid (ARA), and a mixture of at least two thereof.

The encapsulated ingredient is preferably a liquid at a temperature of 45° C. and a pressure of 1 atmosphere.

The encapsulated material is preferably present in the delivery system in an amount ranging from about 5% to about 40% by weight, based on the total weight of the delivery system.

A viscosity modifier may be present as an optional ingredient in the delivery system. The viscosity modified is useful to aid the extrusion process. It may be added to the active ingredient at any time prior to or during the extrusion process. Examples of suitable viscosity modifiers include ethyl cellulose (e.g. the Ethocel range from Dow Chemicals), hydrophobic silicas, silicone oils, high viscosity triglycerides, organophilic clay, oil soluble polymers, high viscosity mineral oil (paraffinic and naphthenic liquid hydrocarbons), oleum treated and hydrogenated mineral oils, petroleum jelly, microcrystalline waxes and paraffin waxes. Preferably it is selected from ethyl cellulose (e.g. the Ethocel range from Dow Chemicals), hydrophobic silicas and organophilic clay.

The most preferred viscosity modifier is ethyl cellulose since it is found to provide the additional advantage of having surface active properties that lower the interfacial tension between a material to be encapsulated and the encapsulating carrier, thereby lowering the energy required during the extrusion process.

Preferably, the molecular weight of the ethyl cellulose is preferably within the range of from 50′000 to 2′000′000, more preferably from 75′000 to 1′500′000, most preferably from 100′000 to 1′250′000.

Preferably, the viscosity of the modified cellulose ether is from 50 mPa.s to 1′000 mPa.s, more preferably 75 mPa.s to 750 mPa.s, most preferably 100 mPa.s to 500 mPa.s, measured as a 5% solution based on 80% toluene 20% ethanol, at 25° C. in an Ubbelohde viscometer.

The amount of viscosity modifier required depends on the nature of the viscosity modifier and the material to be encapsulated and can be adjusted accordingly by the skilled person to achieve the correct viscosity.

It may be desirable to include one or more additional ingredients to increase the solubility or dispersibility of the viscosity modifier.

Optionally and advantageously, an emulsifier may be added to the mixture. This is found to decrease the interfacial tension between the oil and melt phases thereby lowering the energy for droplet formation. Additionally, it can stabilize the droplets once formed. Any emulsifier known to the person skilled in the art can be used. Examples of suitable emulsifiers include lecithin, modified lecithins such as lyso-phospholipids, citric acid esters of mono-and diglycerides (CITREM), diacetyl tartaric acid ester of monoglycerides (DATEM), mono- and diglycerides of fatty acids, sucrose esters of fatty acids, citric acid esters of fatty acids, OSA starch, sodium octenyl succinate modified starch, gum Arabic and other suitable emulsifiers as cited in reference texts such as Food Emulsifiers And Their Applications, 1997, edited by G. L. Hasenhuettl and R. W. Hartel. Most preferred emulsifiers are lecithin, mono- and diglycerides, CITREM and DATEM.

Lecithins and modified lecithins are particularly preferred emulsifiers for use in the present invention. Suitable examples include, but are not limited to soy lecithin (such as Yelkin SS, ex Archer Daniel Midlands) and lyso-phospholipids (such as Verolec HE60, ex Lasenor).

Other optional ingredients can be present in the encapsulating carrier. For instance, a further plasticizer such as water may be present to modify the characteristics of the non-crystalline component of the carrier. Preferably the plasticizer is used in an amount of less than 10%, more preferably less than 9.5%.

Similarly, adjuvants such as food grade colorants can also be added in a generally known manner, to the extrudable mixtures of the invention so as to provide colored delivery systems.

If desired, an anticaking agent can be added to the extruded product to reduce the risk of the granules from sticking to one another, especially during the crystallization phase, until the crystallization is complete.

The extruded delivery system can be provided in any shape that can be obtained using extrusion processes. Such processes are known to the person skilled in the art. For example it can be provided as particles, droplets, fibers, rods or sheets. preferably it is provided in the form of rods or droplets.

Another aspect of the present invention relates to the use as flavoring ingredient of a delivery system according to the invention. In other words, the present invention concerns a method to confer, enhance, improve or modify the taste properties of a flavoring composition or of a flavored article, which method comprises adding to said composition or article an effective amount of at least a delivery system according to the invention. In the context of the present invention, “use of delivery system according to the invention” includes the use of any composition containing said delivery system and which can be advantageously employed in the flavor industry as active ingredient.

Therefore in another aspect, the invention provides a flavoring composition comprising:

i) as a flavoring ingredient, at least one delivery system according to the invention;
ii) at least one ingredient selected from the group consisting of a flavor carrier and a flavor base; and
iii) optionally at least one flavor adjuvant.

By “flavor carrier” we mean here a material which is substantially neutral from a flavor point of view, insofar as it does not significantly alter the organoleptic properties of flavoring ingredients. The carrier may be a liquid or a solid.

Suitable liquid carriers include, for instance, an emulsifying system, i.e. a solvent and a surfactant system, or a solvent commonly used in flavors. A detailed description of the nature and type of solvents commonly used in flavor cannot be exhaustive. Suitable solvents include, for instance, propylene glycol, triacetine, triethyl citrate, benzylic alcohol, ethanol, vegetable oils or terpenes.

Suitable solid carriers include, for instance, absorbing gums or polymers, or even encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or yet the materials cited in reference texts such as H. Scherz, Hydrokolloids: Stabilisatoren, Dickungs- und Gehermittel in Lebensmittel, Band 2 der Schriftenreihe Lebensmittelchemie, Lebensmittelqualität, Behr' s VerlagGmbH & Co., Hamburg, 1996. Encapsulation is a well known process to a person skilled in the art, and may be performed, for instance, using techniques such as spray-drying, agglomeration, extrusion, coacervation and the like.

By “flavor base” we mean here a composition comprising at least one flavoring ingredient.

Said flavoring ingredient is a compound, which is used in flavoring preparations or compositions to impart a hedonic effect. In other words such an ingredient, to be considered as being a flavoring one, must be recognized by a person skilled in the art as being able to impart or modify in a positive or pleasant way the taste of a composition, and not just as having a taste.

The nature and type of the flavoring ingredients present in the base do not warrant a more detailed description here, the skilled person being able to select them on the basis of its general knowledge and according to intended use or application and the desired organoleptic effect. In general terms, these flavoring co-ingredients belong to chemical classes as varied as alcohols, aldehydes, ketones, esters, ethers, acetates, nitriles, terpenoids, nitrogenous or sulphurous heterocyclic compounds and essential oils, and said perfuming co-ingredients can be of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of flavor. It is also understood that said co-ingredients may also be compounds known to release in a controlled manner various types of flavoring compounds.

By “flavor adjuvant” we mean here an ingredient capable of imparting additional added benefit such as a color, a particular light resistance, chemical stability, and so on. A detailed description of the nature and type of adjuvant commonly used in flavoring bases cannot be exhaustive. Nevertheless, such adjuvants are well known to a person skilled in the art, but it has to be mentioned that said ingredients are well known to a person skilled in the art.

A composition consisting of at least one delivery system according to the invention and at least one flavor carrier represents a particular embodiment of the invention as well as a flavoring composition comprising at least one delivery system according to the invention, at least one flavor carrier, at least one flavor base, and optionally at least one flavor adjuvant.

Moreover, a delivery system according to the invention can be advantageously incorporated into flavored articles to positively impart, or modify, the taste of said articles. Thus, in yet another aspect, the present invention provides a flavored article comprising:

i) as taste-conferring or modifying ingredient, at least one delivery system according to the invention, as defined above; and
ii) an edible composition.

Suitable edible compositions, for instance, it can pharmaceutical compositions, nutraceutical compositions, foodstuff bases, chewing-gum or oral-care compositions such as mouthwashes or toothpastes. Preferably, it is used to enhance products which contain water or which are used in the presence of water. Indeed, the delivery system of the invention is preferably water-soluble.

If the active ingredient is a flavors oil, it can be advantageously used to impart or modify the organoleptic properties of a great variety of edible compositions, i.e. foodstuff bases, beverages, pharmaceuticals and the like. In a general manner, they enhance the typical organoleptic effect of the corresponding unextruded flavor material.

Where the active material is an oil rich in polyunsaturated fatty acids or a nutraceutical composition comprising such an oil, it can be provided in any foodstuff base where health benefits are desired. In such products, a further advantage of the present delivery system is that it can mask the flavor of the oil rich in polyunsaturated fatty acids, which may not be compatible with the flavor of the foodstuff base into which it is incorporated.

According to a particular embodiment of the invention, said foodstuff bases can be advantageously a beverage, particularly instant or powdered beverages, wherein the current delivery system can be used to entrap a highly volatile compound such as acetaldehyde at higher levels than in method of the prior art, or a savory food wherein the current delivery can be used to entrap a highly volatile compound such as dimethyl sulphide at higher levels than in method of the prior art.

Typical examples of said foodstuff bases include:
instant or powdered teas, coffee, and fruit juices;
confections, dry cereals;
dry doughs, such as cake or bread mixes;
a seasonings or condiment, such as a stock, a savory cube, a powder mix;
an instant or powdered soup, such as a clear soup, a cream soup, a chicken or beef soup or a tomato or asparagus soup;
a carbohydrate-based products, such as instant noodles, rice, pasta, potatoes flakes or fried, noodles, pizza, tortillas, wraps;
a savory product, such as a snack, a biscuit (e.g. chips or crisps) or an egg product, a potato/tortilla chip, a microwave popcorn, nuts, a bretzel, a rice cake, a rice cracker, etc;
a pet or animal food.

For the sake of clarity, it has to be mentioned that, by “foodstuff” we mean here an edible product, e.g. a food or a beverage. Therefore, a flavored article according to the invention comprises one or more delivery system according to the invention, as well as optional benefit agents, corresponding to taste and flavor profile of the desired edible product.

The nature and type of the constituents of the foodstuffs or beverages do not warrant a more detailed description here, the skilled person being able to select them on the basis of his general knowledge and according to the nature of said product.

The proportions in which the delivery system according to the invention can be incorporated into the various aforementioned articles or compositions vary within a wide range of values. These values are dependent on the nature of the article to be flavored and on the desired organoleptic effect as well as the nature of the co-ingredients in a given base when the delivery system according to the invention are mixed with flavoring co-ingredients, solvents or additives commonly used in the art.

In the case of flavoring compositions, typical concentrations are in the order of 0.05% to 30%, more preferably 0.1% to 20%, most preferably 0.1% to 10%, of the compounds of the invention based on the weight of the flavoring compositions into which they are incorporated. Concentrations lower than these, such as in the order of 0.5 ppm to 300 ppm by weight, more preferably 5 ppm to 75 ppm, most preferably 8 to 50 ppm, can be used when these compounds are incorporated into flavored articles, the percentage being relative to the weight of the article.

The delivery system of the invention is prepared by extrusion. It can be formed using any current extruder typically used according to prior known “wet extrusion” or “dry blend” (also called “flash-flow”) techniques, the latter requiring feeding of a melt of an originally mainly solid mass into the extruder, and the former requiring the extrusion of a mainly fluid mass melt resulting from the prior solution of the encapsulating materials in a suitable solvent.

By extrusion methods we mean here methods according to which, typically, the components which form the encapsulating component, the material that is to be encapsulated and any further optional ingredient as mentioned above, in the form of a melt-emulsion, are forced through a die, a needle or a spray nozzle and then solidified to form a solid product having the encapsulated material dispersed therein. The term “melt-emulsion” denotes a liquid matrix as a continuous phase with particles, preferably hydrophobic particles, dispersed therein as the dispersed phase.

The crystalline and non-crystalline components can be mixed according to any suitable method. For instance, they can simply be premixed as a melt in a hopper without any special equipment. Alternatively, they can be melted directly in a typical extruder.

The melt can be formed in any way known in the art. This includes the heating of encapsulating components to a temperature which allows the formation of an homogeneous melt, for example in a single or twin screw extruder. An alternative example is the dissolution of encapsulating components in a solvent, preferably water, followed by the removal of some or all of this solvent by evaporation.

In a second step of the process, the active ingredient is incorporated into the melt. Such incorporation can be done using any method known in the art. Typically, the active ingredient can be admixed with the melt in a molten state. Alternatively, a melt can be prepared first with the encapsulating material components and be solidified, the active ingredient being then added to the solidified melt, for instance by plating or spraying the active on the solidified melt. In the case where the active is added to a solidified melt, the solidified melt has to be molten again after addition of the active ingredient, so as to form a melt-emulsion in the third step of the process.

The step of forming a melt-emulsion can also be performed using any method known in the art. The melt-emulsion is characterized by the fact that droplets of the active ingredient (encapsulated, dispersed phase) are dispersed within the molten encapsulating carrier (encapsulating, continuous phase).

As used herein, the term “particles” means both solid particles and liquid droplets.

In step d), the extruded product can be formed into any shape that can be obtained using extrusion processes and in particular into granules, powders and sheets. Typically, the term granules includes particles, droplets, fibers and rods. preferably it is provided in the form of rods or droplets. The extrusion can be carried out by any suitable means, which are known to the person skilled in the art. For instance, the extruded product can be chopped whilst it is still in a plastic state (melt granulation or wet granulation techniques), or it can be cooled in a liquid solvent to form the extruded solid, the shape and size of which can be adjusted as a function of the extrusion parameters before being ground, pulverized or the like.

If desired the die orifice itself can be equipped with a cutter-knife or any other cutting device. Alternatively, the cutting device can be provided separately downstream from the die orifice.

The next step of the process is that of tempering the extruded product so as to crystallize the crystal-forming component. The conditions leading to such crystallisation are preferably tempering in a range sufficiently below the melting point of the crystal-forming material so as to provide a thermodynamic driving force for crystallization, yet sufficiently above the glass transition temperature of the remaining amorphous fraction so as to impart sufficient molecular mobility to enable crystallization.

Such tempering can be administered for example using a steel belt or fluidized bed to suspend the granules. Optionally a portion of the tempering can be administered while the melt-emulsion is still within the extruder. In this way crystallization may initiate in the extruder, yet does not take place to an extent that prohibits extrusion.

Optionally the granules can be tempered first at a low temperature (as low even as the glass transition temperature of the melt mixture or below) in order to form crystal nuclei and second at a higher temperature to facilitate crystal growth.

Optionally the granules can be exposed to shear, sonication or modulation in pressure, mixed with a nucleating agent, or treated by any other method known to promote crystallization.

The tempering step of the process is continued until a sufficient part of component (i) of the melt is crystallized so as to obtain a sufficient elevation of the Tg and increase in viscosity. The required level of crystallization is determined based on simple experiments, depending on the desired stability of the delivery system.

One particular aspect of the process of the invention is a process for preparing an extruded delivery system comprising the steps of:

(a) forming a melt comprising (i) a crystal-forming component having a Tg below 30° C. and (ii) a glass-forming component;
(b) quenching the melt to form a vitreous cryogenic solid;
(c) grinding the solid mass to form a fine powder;
(d) plating onto the powder an active ingredient;
(e) warming to form a melt-mixture comprising an emulsion, dispersion, solution or suspension of the active ingredient in the melt;
(f) extruding the melt mixture, and
(g) tempering the extruded product under conditions that enable crystallization of at least part of the crystal-forming component (component (i)) of the melt;
so as to form a solid delivery system.

More particularly, in the case where the active ingredient is a protein, for example an enzyme, the latter specific process is preferably used.

### EXAMPLES

The invention will now be described in further detail by way of the following examples.

### Example 1

Preparation of an Extruded Delivery System

An extruded delivery system according to the invention was prepared having the ingredients listed in Table 1.

TABLE 1

| Ingredient | Grams |
|---|---|
| Erythritol (1) | 126 |
| Hydrogenated starch hydrosolate (2) | 54 |
| Limonene | 18 |
| Lecithin (3) | 2 |

(1) Cargill Inc.
(2) Lab9101, origin: Roquette-Frères, France
(3) Yelkin ® SS, origin: Archer Daniels Midland Company

The erythritol and the hydrogenated starch hydrosolate powders were blended in a steel pan. The mixture was placed on a stove and heated while stirring to achieve a melt. Vacuum was applied to remove the trapped air bubbles. After sufficient heating, mixing and vacuum, the mixture took the form of a clear single-phase liquid. A solution of the limonene and the lecithin was added to the melt at 130° C. and dispersed by mixing with a hand mixer (Ika Werks Inc., T25 Ultra Turrax) for approximately 30 seconds. The resulting melt-emulsion was then transferred to the barrel of a capillary rheometer (Malvern Instruments Ltd., RH2000). The melt emulsion was extruded through a 500 μm die at 130° C. using a piston speed of 50 mm/min The extrudate fell approximately 10 cm before landing on a room temperature (25° C.) metal sheet. At this stage the extrudate was in the form of drops of the still plasticized and relatively low viscosity and translucent melt emulsion. The metal sheet was then placed into a 60° C. oven for 5 minutes. On removal the extrudate was noticeably whiter and more opaque. Also, the extrudate was sufficiently solid that it could be knocked off of the metal sheet with a spatula and collected in a vial without the particles sticking together or coalescing.

### Example 2

Analysis of the Extruded Delivery System prepared in Example 1

### Viscosity

A sub-sample of the erythritol/HSH co-melt (before extrusion) was characterized using a rotational rheometer (TA Instruments, AR2000). Viscosity was measured at 130° C. and found to be 129 mPa.s, which is low compared to conventional melts used in extrusion processes. Viscosity was also measured during cooling of the extruded product and found to increase with a smooth and continuous trend until it reached 4.8*10³ mPa.s at 68° C. A person skilled in the art would agree that this increase does not imply that crystallization occurs. Instead, the increase is typical of that expected with the reduction in free volume on cooling any liquid and could be modelled, for example, using the VFT or WLF equations. Below 68° C., the melt partially crystallized. This was evident as the material quickly took on a white opaque appearance and viscosity departed from WLF behaviour exceeding the limit of the rheometer.

### Calorimetry

The encapsulate produced in Example 1 was also examined using a calorimeter (TA Instruments, Q200). The first heating scan showed an inflection in heat flow (i.e. a glass transition) with a midpoint of 44.95° C. and ΔCp of 0.11 J/(g° C.). Thus the encapsulate has a surprisingly high Tg for an encapsulating carrier with such low melt viscosity. Additionally, the ΔCp value is low, which suggests that only a fraction of the material is in the glassy state, the other part being crystalline.

In another experiment, the encapsulate was heated to 140° C. to fully re-melt the erythritol and then quenched at the maximum cooling rate of the calorimeter to −70° C. At such a fast cooling rate erythritol was not afforded the time to crystallize and thus still plasticised the melt to the full extent. The second heating scan showed an inflection in heat flow (i.e. a glass transition) at −37.25° C. with ΔCp of 0.76 J/(g° C.). Thus, the Tg was much lower when erythritol plasticised the encapsulate to the full extent. By comparing the first and second calorimetry experiments, it appears that the tempering or crystallization step increased the Tg of the extrudate by 82° C.

### Concentration of Limonene

The concentration of limonene within the Example 1 encapsulate particles was measured by TD-LF-NMR and found to be 8.95%. Thus, encapsulation efficiency was 89.5%.

### Example 3

Preparation of an Extruded Delivery System

An amount of 120 g of erythritol (Origin Cargill Inc.) and 80 g of hydrogenated starch hydrosolate (Lab9101, ex Roquette-Freres, France) powders were blended in a steel pan. The mixture was placed into an oven at 160° C. to achieve a melt. After sufficient heating and mixing, the mixture took the form of a clear single-phase liquid. The melt was transferred to a pressurizable vessel and prilled through a 22 gauge needle under 30 psi of nitrogen head pressure. The drips of melt landed in a 500 mL graduated cylinder filled with liquid nitrogen and were vitrified. After decanting the liquid nitrogen, the resulting glassy beads were ground whilst cold in an IKA Werks A11 mill to produce a fine powder. The powder was collected in a container and placed into a −80° C. freezer to allow any remaining liquid nitrogen to evaporate off.

Once dry, 3.9 g of cold limonene was plated onto 71.2 g of the glassy erythritol/HSH powder by mixing with a spatula. This mixture was dispensed into the barrel of a capillary rheometer (Malvern Instruments Ltd., RH2000) which had been tempered to 5° C. The piston was advanced until the instrument registered a normal force of 1 kN. The goal of this step was to de-air and compress the powder while it was still in the glassy state. At this stage a pressure transducer near the die registered 0 MPa presumably because particle friction made transforming the normal force into pressure inefficient. The piston was then stopped to allow time for the powder mixture to warm to 5° C. (approximately 5 minutes). This temperature was above the glass transition temperature and therefore the glassy powder was transformed into a supersaturated viscous liquid. The piston was advanced at 10 mm/min and readings on the pressure gauge increased. The observation that normal force was efficiently transformed into an increase in pressure suggested that the mixture was in the liquid state at this stage. The melt was extruded through a 1 mm diameter zero-length die and formed a flexible strand. Approximately three minutes after landing on a room temperature (25° C.) metal sheet, the strands were rigid. The material was knocked off of the metal sheet and broken up by brittle fracture. The encapsulate was sufficiently solid that it could be stored in a glass vial without particles sticking or coalescing.

### Example 4

Analysis of the Extruded Delivery System Prepared in Example 3

### Calorimetry

The encapsulate produced in Example 3 was examined using a calorimeter (TA Instruments, Q200). The first heating scan showed an inflection in heat flow (i.e. a glass transition) with an onset of 25.4° C., midpoint of 35.4° C. and ΔCp of 0.11 J/(g° C.). Thus, the encapsulate had a surprisingly high Tg for an encapsulating carrier that was extruded at 5° C. Additionally, such ΔCp value is low, which suggests that only a fraction of the material was in the glassy state, the other part being crystalline.

The encapsulate was heated to 140° C. to fully re-melt the erythritol and then quenched at the maximum cooling rate of the calorimeter to −70° C. At such a fast cooling rate erythritol was not afforded the time to crystallize and thus still plasticised the melt to the full extent. The second heating scan showed an inflection in heat flow (i.e. a glass transition) at −33.9° C. with ΔCp of 0.73 J/(g° C.). Thus, the Tg was much lower when erythritol plasticised the encapsulate to the full extent. The crystallization step increased the Tg of the extrudate by 69° C. compared to the fully molten mixture.

Concentration of Limonene

The concentration of limonene within the Example 3 encapsulate particles was measured by TD-LF-NMR and found to be 4.58%. Thus, encapsulation efficiency was 88.9%.

### Example 5

Preparation of a n Extruded Delivery System

An amount of 100 g of erythritol (Origin Cargill Inc.) and 100 g of hydrogenated starch hydrosolate (Lab9101, ex Roquette-Freres, France) powders were blended in a steel pan.

The mixture was placed into an oven at 160° C. to achieve a melt. After sufficient heating and mixing, the mixture took the form of a clear single-phase liquid. The melt was transferred to a pressurizable vessel and prilled through a 22 gauge needle under 30 psi of nitrogen head pressure. The drips of melt landed in a 500 mL graduated cylinder filled with liquid nitrogen and were vitrified. After decanting the liquid nitrogen, the resulting glassy beads were ground whilst cold in an IKA Werks A11 mill to produce a fine powder. The powder was collected in a container and placed into a −80° C. freezer to allow any remaining liquid nitrogen to evaporate off.

Once dry, 5 g of cold acetaldehyde (at −80° C.) was plated onto 95.0 g of the glassy erythritol/HSH powder by mixing with a spatula. This mixture was dispensed into the barrel of a capillary rheometer which had been tempered to 15° C. (Malvern Instruments Ltd., RH2000) which had been tempered to 15° C. The piston was advanced until the instrument registered a normal force of 1 kN. The goal of this step was to de-air and compress the powder while it was still in the glassy state. At this stage a pressure transducer near the die registered 0 MPa presumably because particle friction made transforming the normal force into pressure inefficient. The piston was then stopped to allow time for the powder mixture to warm to 15° C. (approximately 5 minutes). This temperature was approximately 45° C. above the glass transition temperature and therefore the glassy powder was transformed into a supersaturated viscous liquid. The aim of warming the fine acetaldehyde/powder dispersion was to provide mobility to the individual encapsulating carrier particles, allowing them to coalesce thereby trapping the acetaldehyde in the form of droplets. The piston was advanced at 2 mm/min and readings on the pressure gauge increased. The observation that normal force was efficiently transformed into an increase in pressure suggested that the mixture was in the liquid state at this stage. The melt was extruded through a 1 mm diameter zero-length die and formed a flexible strand. Approximately three minutes after landing on a room temperature (25° C.) metal sheet, the strands were rigid. The material was knocked off of the metal sheet and broken up by brittle fracture. The encapsulate was sufficiently solid that it could be stored in a glass vial without particles sticking or coalescing.

### Example 6

Analysis of the Extruded Delivery System Prepared in Example 5

### Calorimetry

The encapsulate produced in Example 5 was examined using a calorimeter (TA Instruments, Q200). The first heating scan showed an inflection in heat flow (i.e. a glass transition) with an onset of 28.8° C., midpoint of 45.1° C. and ΔCp of 0.31 J/(g° C.). Thus, the encapsulate had a surprisingly high Tg for an encapsulating carrier that was extruded at 15° C. Additionally, the ΔCp value was low, suggesting that only a fraction of the material was in the glassy state, the other part being crystalline.

The encapsulate was heated to 140° C. to fully re-melt the erythritol and then quenched at the maximum cooling rate of the calorimeter to −70° C. At such a fast cooling rate erythritol was not afforded the time to crystallize and thus still plasticised the melt to the full extent. The second heating scan showed an inflection in heat flow (i.e. a glass transition) at −38.4° C. with ΔCp of 0.64 J/(g° C.). Thus, the Tg was much lower when erythritol plasticised the encapsulate to the full extent. The crystallization step increased the Tg of the extrudate by 67° C. compared to the fully molten mixture.

Concentration of Acetaldehyde

The concentration of acetaldehyde within the Example 5 encapsulate particles was measured using reverse phase HPLC after dissolving the encapsulate in water and derivatizing with 2,4-dinitrophenylhydrazine. The concentration was found to be 3.4%. Thus, encapsulation efficiency was 68%.

The degree to which the encapsulate is hermetic was gauged by TGA. Significant levels of volatiles were retained at 30°, well above the boiling point of acetaldehyde. Loss then occurred within the glass transition range (between 30 and 50° C.) and continued above Tg and with melting of the erythritol crystals.

### Example 7

Preparation of Beverages

Beverages were prepared according to Table 2:

TABLE 2

| Component | Sample 1 (TEST) | Sample 2 (CONTROL) |
|---|---|---|
| Sucrose | 70 g | 70 g |
| Citric acid | 0.7 g | 0.7 g |
| Orange flavor (1) | 0.005 g | 0.005 g |
| Encapsulated flavor (2) | 0.176 g | 0 g |
| Erythritol | | 0.085 g |
| Hydrogenated starch | | 0.085 g |
| hydrosolate | | |
| Water | Sufficient to dilute to | Sufficient to dilute to |
| | 1000 mL | 1000 mL |

(1) ex Firmenich, Geneva, Switzerland (reference 596407 MEII)
(2) prepared in Example 5

The beverages were assessed by 18 untrained panelists. Samples were presented blind and followed a balanced presentation order. The panelists were asked to choose which beverage imparted a more fresh or juicy taste. All 18 panelists chose Sample 1.

1. An extruded delivery system comprising:
(a) an encapsulating carrier comprising
i) a crystalline component consisting of a material having a Tg below 30° C. when it is in an amorphous state and
ii) an amorphous component in the glassy state; and
(b) an encapsulated liquid active ingredient.

2. The delivery system according to claim 1 wherein the crystalline component is erythritol, mannitol, sorbitol, xylitol or a mixture thereof.

3. The delivery system according to claim 2 wherein the crystalline component is erythritol.

4. The delivery system according to claim 1 wherein the active ingredient is liquid at a temperature of 45° C. and a pressure of 1 atm.

5. The delivery system according to claim 1 wherein the non-crystalline component has a Tg above 30° C.

6. The delivery system according to claim 1 wherein the non-crystalline component is selected from polysaccharides, proteins, and disaccharides having a Tg above 30° C.

7. The delivery system according to claim 1 wherein the non-crystalline component is one or more hydrogenated starch hydrolysate having a number average degree of polymerization (DPn) of between 5 and 100 or a number average molecular weight (Mn) of between 800 and 16000 Da.

8. The delivery system according to claim 1 wherein the crystalline component (component (i)) is present in an amount of between 10 and 90% by weight based on the total dry weight of components (i) and (ii).

9. The delivery system according to claim 8 wherein the crystalline component (component (i)) is present in an amount of at least 30% by weight based on the total dry weight of components (i) and (ii).

10. The delivery system according to claim 1, further comprising an emulsifier.

11. The delivery system according to claim 9 wherein the emulsifier is selected from lecithin, modified lecithins, mono- and diglycerides of fatty acids, sucrose esters of fatty acids, citric acid esters of fatty acids, Octenyl succinic anhydride (OSA) starch, sodium octenyl succinate starch, gum Arabic, citric acid esters of mono-and diglycerides (CITREM) and diacetyl tartaric acid ester of monoglycerides (DATEM).

12. The delivery system according to claim 1 wherein the encapsulated phase represents between 5 and 40% by weight, based on the total weight of the extruded delivery system.

13. A method of preparing an extruded delivery system comprising the steps of:
(a) forming a melt comprising (i) a crystal-forming material having a Tg below 30° C. and (ii) a glass-forming material;
(b) incorporating an active ingredient into the melt;
(c) forming a melt-mixture comprising an emulsion, dispersion, solution or suspension of the active ingredient in the melt;
(d) extruding the melt mixture, and
(e) tempering the extruded melt under conditions that enable crystallization of at least part of component (i) of the melt;
so as to form a solid delivery system.

14. A flavoring composition comprising:
i) as a flavoring ingredient, at least one delivery system according to claim 1;
ii) at least one ingredient selected from the group consisting of a flavor carrier and a flavor base; and
iii) optionally at least one flavor adjuvant.

15. A flavored article comprising:
i) as taste-conferring or modifying ingredient, at least one delivery system according to the invention, as defined above; and
ii) an edible composition.
